(19) United States
(12) Patent Application Publication
(10) Pub. No.: US 2025/0100077 A1
(43) Pub. Date: Mar. 27, 2025

(54) WIRE OSCILLATION FOR DIRECTED ENERGY DEPOSITION

(71) Applicant: NEXA3D, INC., Ventura, CA (US)

(72) Inventors: William Jack MACNEISH, III, Santa Ana, CA (US); Quinlan Yee SHUCK, Troy, MI (US)

(21) Appl. No.: 18/729,076

(22) PCT Filed: Feb. 16, 2023
(86) PCT No.: PCT/US2023/062715

§ 371 Date: Jul. 15, 2024

Related U.S. Application Data
(60) Provisional application No. 63/310,985, filed on Feb. 16, 2022.

(51) Int. Cl. B23K 26/342; B23K 26/14; B33Y 10/00; B33Y 30/00; B33Y 40/00

(52) U.S. Cl. CPC B23K 26/342; B23K 26/1464; B33Y 10/00; B33Y 30/00; B33Y 40/00

(57) ABSTRACT

A wire feed head for directed energy deposition, a system including a wire feed head, and methods of directed energy deposition. The wire feed head includes a collet connected to a housing, an energy emitter connected to the housing, and an energy pathway defined in the housing connected to the energy emitter. The wire feed head also includes a wire feed pathway defined in the collet and an oscillator coupled to at least one of the collet, the energy emitter, and the energy pathway. The method includes feeding a feed wire through a feed pathway in a wire feed head, emitting energy from an energy source, directing the emitting energy towards the feed wire exiting the feed pathway, and oscillating at least one of the feed wire and the emitted energy relative to the other.

### RELATED APPLICATIONS

This application is a National Stage under 35 USC 371 of and claims priority to International Application No. PCT/US2023/062715, filed 16 Feb. 2023, which claims the priority benefit of U.S. Application No. 63/310,985, filed 16 Feb. 2022.

### FIELD

The present disclosure is directed to the oscillation of the feed wire in directed energy deposition.

### BACKGROUND

Directed energy deposition is an additive manufacturing process that utilizes a focused energy source, such as a laser, plasma arc, or electron beam, to melt and fuse a feedstock. The feedstock is deposited on a build surface layer by layer to form a three-dimensional component or to repair an existing three-dimensional component. As each layer is being deposited, it fuses to the previously deposited layer. Feedstock materials generally include metals and metal alloys; however, other feedstocks such as polymers and ceramics may also be used. Further, the feedstock may be supplied in powder or wire form, each with its own advantages.

In aspects, where the feedstock is deposited in wire form, wire position is affected by a number of characteristics, including variations in wire diameter, variations in wire straightness, residual wire stress, amount of cold work, and annealing that may occur during the deposition/retraction process. These variations may lead to variations in melt characteristics ultimately affecting the properties of the deposited material. Accordingly, consistent wire location relative to the energy source is a relatively important factor in the directed energy deposition process.

Thus, while current direct energy processes achieve their intended purpose, there is a need for a new and improved system and process for directed energy deposition.

### SUMMARY

According to various aspects, the present disclosure is directed to a wire feed head for directed energy deposition. The wire feed head includes a collet connected to a housing, an energy emitter connected to the housing, and an energy pathway defined in the housing connected to the energy emitter. The wire feed head also includes a wire feed pathway defined in the collet and an oscillator coupled to at least one of the collet, the energy emitter, and the energy pathway.

In embodiments of the above, the energy emitter comprises a laser and the energy pathway is defined by laser optics. In further embodiments, the laser optics include a mirror and a focusing lens. Alternatively, or additionally, the energy emitter comprises a microwave emitter and the energy pathway is defined by a wave guide. Alternatively, or additionally, the energy emitter comprises a plasma emitter and the energy pathway is defined by a plasma flow channel.

In any of the above embodiments, the oscillator includes one or more oscillators from the group consisting of: a haptic actuator and a piezo actuator. Alternatively, or additionally, in embodiments, the oscillator includes a magnet connected to the collet and a coil connected to the housing.

According to various aspects, the present disclosure also relates to a system for directed energy deposition. The system includes a wire feed head including a collet connected to a housing, an energy emitter connected to the housing, an energy pathway defined in the housing, a wire feed pathway defined in the collet, and an oscillator coupled to at least one of the collet, the energy emitter, and the energy pathway.

In embodiments, the system further includes a gantry. The wire feed head is mounted to the gantry movable in a first and second axis. In further embodiments, the system includes a support bed. The support bed is movable in a third axis.

In any of the above embodiments, the energy emitter comprises a laser and the energy pathway is defined by laser optics. In further embodiments, the laser optics include a mirror and a focusing lens. In alternative or additional embodiments, the energy emitter includes a microwave emitter and the energy pathway is defined by a wave guide. In alternative or additional embodiments, the energy emitter comprises a plasma emitter and the energy pathway is defined by a plasma flow channel.

In any of the above embodiments, the oscillator includes one or more oscillators from the group consisting of: a haptic actuator and a piezo actuator.

In any of the above embodiments, the oscillator includes a magnet connected to the collet and a coil connected to the housing.

According to various aspects, the present disclosure further relates to a method for directed energy deposition. The method includes feeding a feed wire through a feed pathway in a wire feed head, emitting energy from an energy source, directing the emitting energy towards the feed wire exiting the feed pathway, and oscillating at least one of the feed wire and the emitted energy relative to the other.

In embodiments of the above, the method includes oscillating the at least one of the feed wire and the emitted energy at a frequency in the range of 10 hertz to 100 hertz.

In any of the above embodiments, the method includes oscillating the at least one of the feed wire and the emitted energy at an amplitude of 10 percent to 80 percent of the wire diameter.

According to various aspects, the present disclosure yet further relates to a method for directed energy deposition. The method includes feeding a feed wire through a feed pathway in a wire feed head, emitting a coherent light beam from a laser source, and directing the light beam towards the feed wire exiting the feed pathway. The method also includes measuring a deviation of the feed wire from a predefined location downstream of the feed pathway and oscillating at least one of the feed wire and the coherent light beam relative to the other based on the deviation of the feed wire.

### BRIEF DESCRIPTION OF THE FIGURES

The drawings described herein are for illustration purposes only and are not intended to limit the scope of the present disclosure in any way.

FIG. 1 illustrates a directed energy deposition additive manufacturing system;

FIG. 2 illustrates a wire feed head integrated with a laser;

FIG. 3A illustrates feed wire of inconsistent geometry exiting the collet; and

FIG. 3B illustrates feed wire of relatively consistent geometry exiting the collet.

### DETAILED DESCRIPTION

The present disclosure is directed to a system and process of directed energy deposition of wire, wherein one of the wire or the energy source is oscillated to provide an average wire position relative to the incident energy source. During directed energy deposition, wire position is often difficult to control due to changes in wire diameter, poor wire straightness, residual wire stress, amount of cold work, and annealing that may occur during the deposition/retraction process. The present disclosure relies upon wobbling or oscillating the wire relative to the energy source, by either oscillating the wire or the energy source to improve average positional accuracy and resulting power absorption. The oscillation may also have the added benefit of agitating the melt zone in the feed wire and previously deposited traces, refining the grain size, and reducing anisotropy.

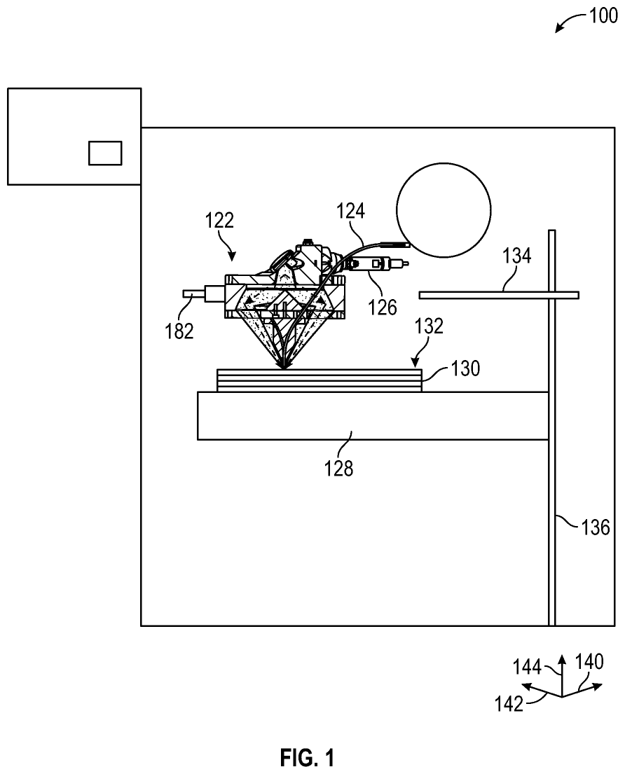

FIG. 1 illustrates an example of a directed energy deposition system 100 including wire feed head 122, feed wire 124, and energy emitter 126. The wire feed head 122 positions the feed wire 124 relative to a support bed 128 and previously deposited traces 130 of a three-dimensional component 132, which are supported by the support bed 128. The energy emitter 126 directs an energy source towards the feed wire 124, melting the feed wire 124 to consolidate the feed wire 124 with the previously deposited traces 130 of feed wire 124. In aspects, the wire feed head 122 is carried on a first gantry 134 allowing motion in a first axis 140 and a second axis 142 and the support bed 128 is carried on a second gantry 136 allowing motion in a third axis 144. In other aspects, the first gantry 134 may provide motion in the third axis 144 and the second gantry 136 may provide motion in the first axis 140, 142.

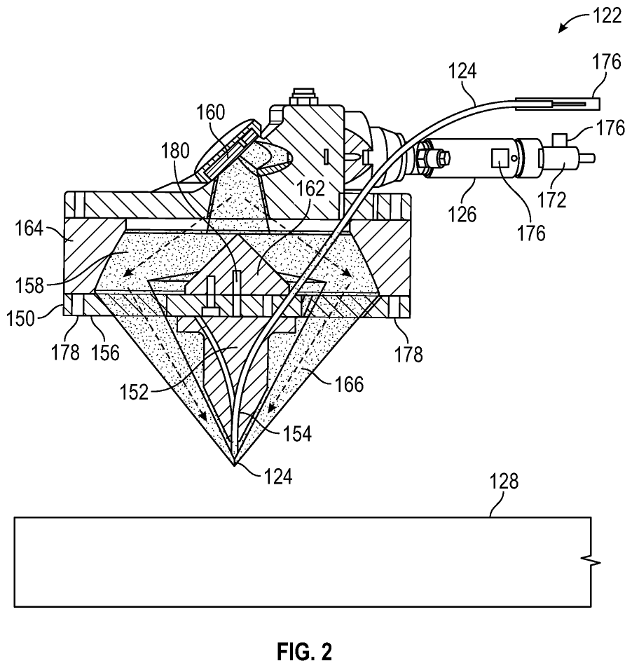

FIG. 2 illustrates the wire feed head 122 integrated with the energy emitter 126, which in the illustrated aspect is a laser. In alternative aspects, the wire feed head 122 and energy emitter 126 are individual assemblies. The wire feed head 122 includes a housing 150. Mounted to the housing 150 is a collet 152, which includes one or more feed pathways 154 defined therein for feeding the feed wire 124 to the support bed 128 or previously deposited traces 130 (see FIG. 1). The collet 152 extends from the base 156 of the housing and towards the support bed 128. In addition, mounted on the housing 150, are the laser 126 and an energy pathway 158 connected to the laser. The energy pathway 158 is defined in the housing by e.g., laser optics 160, 162, 164 for directing the coherent light beam 166 emitted by the laser towards the feed wire 124. In aspects where the energy emitter 126 is a device other than a laser, the laser optics 160, 162, 164 may be replaced by a waveguide where the energy emitter includes a microwave emitter, or appropriate plasma flow channels where the energy emitter 126 is a plasma emitter. The laser optics 160, 162, 164 include one or more mirrors or focusing lenses for adjusting the pathway of the photons emitted by the laser source 126. The photons emitted by the laser 126 form a coherent beam of light 166 (the light field) that is incident to the feed wire 124 exiting the feed pathway 154 defined in the collet 152. The feed wire 124 is softened or at least partially melted, and in aspects completely melted, by the laser 126 and consolidates with the previously deposited trace 130.

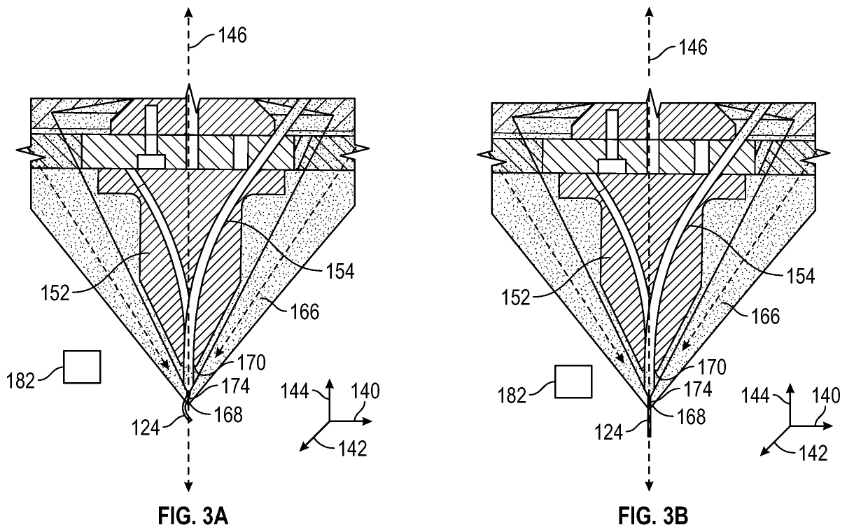

However, as the position of the feed wire 124 is often difficult to control due to changes in wire diameter, poor wire straightness, residual wire stress, amount of cold work, and annealing that may occur during the deposition/retraction process, the coherent beam of light 166 from the energy emitter 126 may be uniformly incident on the feed wire 124. FIGS. 3A and 3B illustrate an example of feed wires 124 as they are exiting the feed pathway 154 defined in the collet and being deposited on a previously deposited trace 130. The coherent beam of light 166 forms a melt zone of the feed wire 124 and, in some aspects, the previously deposited traces 130. As the feed wires 124 pass through the beam of light 166, alterations in feed wire 124 geometry may result in uneven exposure of the feed wire 124 to the coherent beam of light 166 and the melt zone. FIG. 3A illustrates an example where the feed wire 124 bends to one side, such that this portion of the feed wire 124 is exposed to coherent light beam 166 for a lower time period than straighter feed wire portions are exposed (see FIG. 3B). Further, in the illustrated example, the feed wire 124 exits the coherent beam of light 166 before it passes through the focal point 168 of the coherent light beam 166.

To compensate for the discontinuity in exposure of the feed wire 124 to the coherent light beam 166 emitted by the laser source 126, the feed wire 124 or the coherent light beam 166 is oscillated in at least one axis of the first axis 140 and second axis 142. And, in further aspects, the feed wire 124 or the coherent light beam 166 is also oscillated in the third axis 144. Oscillation is provided by: vibrating the laser inlet 172 relative to one or more components of the laser optics 160, 162, 164 or vibrating one or more of the laser optics 160, 162, 164 relative to the laser inlet 172; vibrating one or more components of the laser optics 160, 162, 164, or all of the laser optics 160, 162, 164 as a group, relative to the laser inlet 172 and the collet 152, the feed wire 124, or the collet 152 and feed wire 124; or vibrating the collet 152 relative to the laser optics 160, 162, 164. In aspects, the oscillations are of relatively small amplitude, such as in the range of 10 percent to 80 percent of the wire diameter, including all values and ranges therein, such as 50 percent of the wire diameter. In aspects, the amplitude of the oscillations are 0.2 to 1.0 millimeters, including all values and ranges therein. Further, in aspects, the oscillations are provided at a frequency in the range of 10 hertz to 100 hertz, including all values and ranges therein. In aspects, the oscillations occur in at steady frequencies or amplitudes or, in alternative aspects, the oscillations occur at random frequencies and amplitudes.

In further aspects, the oscillation of either the coherent light beam 166 or the feed wire 124 are determined based on a measured deviation of the feed wire 124 from a predefined location in the system after exiting, i.e., downstream of, the feed pathway 154. The predefined location in the system includes, for example, a point 174 at a distance from the exit 170 of the feed pathway 154 on an axis 146 defined by the coherently light beam 166 or the collet 152, wherein the deviation may be a distance between the center of the feed wire 124 cross-section and the point 174. In aspects, the deviation is measured using an optical sensor operating at a wavelength that is different from, and not interfered with by, the coherent laser beam 166. Based on the measured deviation, one of the feed wire 124 or the coherent light beam 166 is oscillated to re-center, or otherwise reposition, the feed wire 124 in the coherent light beam 166.

Oscillations of the feed wire 124 or the coherent light beam 166 are provided by the use of electro and electro-mechanical devices including haptic actuators including vibration imparting motors, including vibrating mini motors available from ADAFRUIT, New York; piezo actuators including biomorph actuators; motor and cam arrangements. An oscillator 176 is affixed to at least one of the collet 152, the energy source 126, the laser inlet 172, and one or more of the laser optics 160, 162, 164, to vibrate that component(s) relative to the other components. In further aspects, coil actuators including a magnet 180 connected to the collet 152 and a coil 178 connected to the housing 150. The application of power to the coil 178 creates movement of the magnet 180.

During the deposition process, the feed wire 124 is fed through a feed pathway 154 in the wire feed head 122. In the illustrated aspect, a coherent light beam 166 is emitted from a laser source 126 and directed through the laser optics 160, 162, 164 providing an energy pathway 158 towards the feed wire 124 exiting the feed pathway 154. At least one of the feed wire 124 and the coherent light beam 166 is oscillated relative to the other. Oscillating either the feed wire 124 or the coherent light beam 166 provides an improved average positional accuracy along the length of the feed wire 124 as it is being deposited to improve power absorption through the cross-section and length of the feed wire 124. As noted above, in aspects, the oscillations are imparted in at least one, or more axes, and, in further aspects, the oscillation is provided in a circular motion to provide oscillation within a defined normal volume of the feed wire 124, wherein the feed wire 124 occupies a space in the coherent light beam 166 for a relatively equal amount of time at the maximum oscillation amplitude.

The system and process of directed energy deposition of the wire disclosed herein offers several advantages. These advantages may include, for example, providing a relatively more consistent average position of the feed wire relative to the incident energy. These advantages further include improvements in the melt properties of the feed wire. Yet further advantages include agitation of the melt zone on the previously deposited traces. These advantages further include improvements in the properties in the resulting three-dimensional component, including, but not limited to, mechanical properties.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A wire feed head for directed energy deposition, comprising:
a collet connected to a housing;
an energy emitter connected to the housing; and
an energy pathway defined in the housing, wherein the energy pathway is connected to the energy emitter;
a wire feed pathway defined in the collet; and
an oscillator coupled to at least one of the collet, the energy emitter, and the energy pathway, wherein the oscillator includes one or more oscillators from the group consisting of: a haptic actuator and a piezo actuator.

2. The wire feed head of claim 1, wherein the energy emitter comprises a laser and the energy pathway is defined by laser optics.

3. The wire feed head of claim 2, wherein the laser optics include a mirror and a focusing lens.

4. The wire feed head of claim 1, wherein the energy emitter comprises a microwave emitter and the energy pathway is defined by a wave guide.

5. The wire feed head of claim 1, wherein the energy emitter comprises a plasma emitter and the energy pathway is defined by a plasma flow channel.

6. (canceled)

7. The wire feed head of claim 1, wherein the oscillator includes a magnet connected to the collet and a coil connected to the housing.

8. A system for directed energy deposition, comprising:
a wire feed head including a collet connected to a housing,
an energy emitter connected to the housing,
an energy pathway defined in the housing, wherein the energy pathway is connected to the energy emitter,
a wire feed pathway defined in the collet,
a gantry, wherein the wire feed head is mounted to the gantry movable in a first and second axis,
a support bed, wherein the support bed is movable in a third axis, and
an oscillator coupled to at least one of the collet, the energy emitter, and the energy pathway, wherein the oscillator includes one or more oscillators from the group consisting of: a haptic actuator and a piezo actuator.

9. (canceled)

10. (canceled)

11. The system of claim 8, wherein the energy emitter comprises a laser and the energy pathway is defined by laser optics.

12. The wire feed head of claim 11, wherein the laser optics include a mirror and a focusing lens.

13. The wire feed head of claim 8, wherein the energy emitter comprises a microwave emitter and the energy pathway is defined by a wave guide.

14. The wire feed head of claim 8, wherein the energy emitter comprises a plasma emitter and the energy pathway is defined by a plasma flow channel.

15. (canceled)

16. The wire feed head of claim 8, wherein the oscillator includes a magnet connected to the collet and a coil connected to the housing.

17. A method for directed energy deposition, comprising:
feeding a feed wire through a feed pathway in a wire feed head;
emitting energy from an energy source, wherein the energy is a coherent light beam emitted from a laser source;
directing the emitting energy towards the feed wire exiting the feed pathway; oscillating at least one of the feed wire and the emitted energy relative to the other;
measuring a deviation of the feed wire from a predefined location downstream of the feed pathway; and
oscillating at least one of the feed wire and the coherent light beam relative to the other based on the deviation of the feed wire.

18. The method of claim 17, further comprising oscillating the at least one of the feed wire and the emitted energy at a frequency in the range of 10 hertz to 100 hertz.

19. The method of claim 17, further comprising oscillating the at least one of the feed wire and the emitted energy at an amplitude of 10 percent to 80 percent of the diameter of the feed wire.

20. (canceled)
